(19) United States
(12) Patent Application Publication
(10) Pub. No.: US 2014/0370188 A1
(43) Pub. Date: Dec. 18, 2014

(54) Absorptive Polarizer and Production Method Therefor

(71) Applicant: DONGWOO FINE-CHEM CO., LTD., Jeollabuk-do (KR)

(72) Inventor: Min Seong Cho, Incheon (KR)

(21) Appl. No.: 14/477,059

(22) Filed: Sep. 4, 2014

Related U.S. Application Data
(63) Continuation of application No. PCT/KR2013/001716, filed on Mar. 4, 2013.

(30) Foreign Application Priority Data
Mar. 5, 2012 (KR) 10-2012-0022127

(51) Int. Cl. G02B 1/08; B29C 70/62; B05D 3/00; G02B 5/30

(52) U.S. Cl. CPC G02B 1/08; G02B 5/3025; B29C 70/62; B05D 3/207; B29L 2011/0066
USPC 427/163.1; 252/585; 264/1.34

(57) ABSTRACT

The present invention relates to an absorptive polarizer and a method for manufacturing the same, and more particularly, to an absorptive polarizer which includes a nano-composite layer in which nanoparticles including a light absorptive element or an oxide or compound thereof are selectively contained in a block copolymer having a first block and a second block which are separately aligned therein, thereby exhibiting excellent durability even when it is exposed under hot and humid environments for a long time, and having polarization degree and transmittance substantially equal to or greater than those of any typical absorptive polarizer manufactured through drawing, as well as a method of easily preparing such an absorptive polarizer as described above at low production costs.

This application is a continuation of Patent Cooperation Treaty application PCT/KR2013/001716, filed Mar. 4, 2013, which claims priority from Korean application no. 10-2012-0022127, filed Mar. 5, 2012, both of which are hereby incorporated by reference herein in their entireties.

### TECHNICAL FIELD

The present invention relates to an absorptive polarizer with excellent durability even when it is exposed to hot and humid environments for a long time, and a method for manufacturing the same.

### BACKGROUND ART

A polarizer refers to an optical device extracting a straight polarized light having a specific vibration direction from non-polarized light such as natural light.

Conventionally, an iodine dyed polyvinylalcohol film-based absorptive polarizer with sufficiently high transmittance and polarization degree has been widely used. However, such a polyvinylalcohol-based absorptive polarizer involves drawbacks of high sublimation of iodine, low durability, and high processing costs due to manufacturing the polarizer through film drawing.

Further, corresponding to the demands of high performance, increase in size, and decrease in film thickness of an image display device, the polarizer also requires high performance and improved diversity in optical properties. Further, an improved polarizer to meet the above-described demands and different methods for manufacturing the same have been proposed.

For example, an extrusion method of a thermoplastic resin after adding a dichroic dye to the thermoplastic resin has been proposed. However, this method has a disadvantage of deteriorated polarization properties due to inefficient alignment of dichroic dye.

Alternatively, a method for alignment of dichroic dye in a polarizer by coating the polarizer with a mixed solution of a copolymer having a linear nano-structure and the dichroic dye has been proposed (see Korean Patent Laid-Open Publication No. 2010-0090921). However, it is difficult to ensure uniformity of alignment of dichroic dye in planes, which thereby may result in inferior polarization properties. Further, the polarizer has reduced durability if it is exposed to hot and humid environments for a long time, hence having a drawback of not retaining polarization properties.

### SUMMARY OF THE INVENTION

### Problems to be Solved by the Invention

Accordingly, it is an object of the present invention to provide an absorptive polarizer with excellent durability, capable of maintaining polarization properties such as polarization degree, transmittance, etc. even when it is exposed to hot and humid environments for a long time.

Further, another object of the present invention is to provide a method for manufacturing the absorptive polarizer with uniformity of nanoparticles in planes, thus having polarization degree and transmittance equal to or greater than those of any conventional absorptive polarizer typically prepared by a drawing process.

### Means for Solving the Problems

The present inventors have found that an improved absorptive polarizer with excellent polarization properties as well as durability can be provided without any additional drawing process by mixing a specific block copolymer with nanoparticles including a light absorptive element or an oxide or compound thereof, and utilizing self-assembly of the block copolymer.

According to one aspect of the present invention, there is provided an absorptive polarizer, including: a nano-composite layer in which nanoparticles including a light absorptive element or an oxide or compound thereof are selectively contained in a block copolymer having a first block and a second block which are separately aligned therein.

The nanoparticles may be subjected to surface treatment so as to have affinity with the first block or the second block.

The nanoparticles may have an average diameter of 1 to 100 nm.

The light absorptive element or an oxide or compound thereof may be at least one selected from a group consisting of Ag, Au, Pt, Ti, Fe, Co, Cr, Cu, Ni, Zn, Mn, Cd, W, Al, Pb, Ga, Si, AS, Fe₂O₃, Fe₃O₄, CrO₂, SiO₂, Al₂O₃, TiO₂, PbS, FeS₂, ZnS,

GaP, GaAs, InP, InAs, InSb and CdSe.

The nanoparticles may be contained in an amount of 0.01 to 30 wt. parts to 100 wt. parts of the block copolymer.

The block copolymer may be at least one selected from a group consisting of poly(styrene-block-methylmethacrylate), poly(styrene-block-4-vinylpyridine), poly(styrene-block-2-vinylpyridine), poly(methylmethacrylate-block-trifluoroethylmethacrylate), poly(methacrylate-block-2-pyranoxyethylmethacrylate), poly(n-butylacrylate-block-dimethylsilane-co-diphenylsilane, poly(t-butylacrylate-block-4-vinylpyridine), poly(t-butylmethacrylate-block-2-vinylpyridine), poly(2-ethylhexylacrylate-block-4-vinylpyridine), poly(2-hydroxylethylacrylate-block-neopentylacrylate), poly(2-hydroxylethylacrylate-block-n-butyl methacrylate), poly(2-hydroxylethylmethacrylate-block-neopentylmethacrylate), poly(2-hydroxylethylmethacrylate-block-t-butylmethacrylate), poly(butadiene(1,2)-block-t-butylacrylate), poly(butadiene(1,4)-block-t-butylacrylate), poly(butadiene(1,2)-block-i-butylmethacrylate), poly(butadiene(1,2)-block-methylmethacrylate), poly(butadiene(1,4)-block-methylmethacrylate), poly(butadiene(1,2)-block-s-butylmethacrylate), poly(butadiene(1,2)-block-t-butylmethacrylate), poly(butadiene(1,4)-block-dimethylsilane), poly(butadiene(1,4)-block-ε-caprolactone), poly(butadiene(1,2)-block-lactide), poly(butadiene(1,4)-block-lactide), poly(butadiene(1,4)-block-4-vinylpyridine), poly(isopropene(1,2)-block-4-vinylpyridine), poly(isopropene(1,4)-block-4-vinylpyridine), poly(isopropene(1,4)-block-2-vinylpyridine), poly(isopropene(1,4)-block-methylmethacrylate(syndiotic)), poly(isobutylene-block-dimethylsilane), poly(isobutylene-block-methylmethacrylate), poly(isobutylene-block-t-butylmethacrylate), poly(isopropene-block-ε-caprolactone), poly(isopro-block-4-vinylpyridine), poly(styrene-block-4-bipyridylmethylacrylate), polystyrene-block-cyclohexylmethacrylate), poly(styrene-block-dispersed 1-acrylate), poly(styrene-block-ethylmethacrylate), poly(styrene-block-lactide), poly(styrene-block-methylmethacrylate), poly(styrene-block-N,N-dimethylaminomethacrylate), poly(styrene-block-n-butylacrylate), poly(styrene-block-n-butylmethacrylate), poly(styrene-block-n-propylmethacrylate), poly(styrene-block-nylon 6), poly(styrene-block-t-butylacrylate), poly(styrene-block-t-butylmethacrylate), poly(styrene-block-ε-caprolactone), poly(styrene-block-2-cholesteryloxycarbonyloxyethylmethacrylate), poly(styrene-block-2-hydroxyethylmethacrylate), poly(styrene-block-2-hydroxypropylmethacrylate), poly(styrene-block-2-vinylpyridine), poly(styrene-block-4-hydroxylstyrene), poly(styrene-block-4-methoxystyrene), poly(styrene-block-4-vinylpyridine), poly(α-methylstyrene-block-4-vinylpyridine), poly(4-aminomethylstyrene-block-styrene), poly (4-methoxystyrene-block-ethylmethacrylate), poly(4-methoxystyrene-block-t-butylacrylate), poly(p-chloromethylstyrene-block-t-butylacrylate), poly(2-vinylnaphthalene-block-methylmethacrylate), poly(2-vinylnaphthalene-block-n-butylacrylate), poly(2-vinylnaphthalene-block-t-butylacrylate), poly(2-vinylpyridine-block-methylmethacrylate), poly(4-vinylpyridine-block-methylmethacrylate), poly(2-vinylpyridine-block-t-butylmethacrylate), poly(2-vinylpyridine-block-methyl acrylic acid), poly(2-vinylpyridine-block-ε-caprolactone), poly(2-vinylpyridine-block-dimethylsiloxane), poly(dimethylsiloxane-block-n-butylacrylate), poly(dimethylsiloxane-block-t-butylacrylate), poly(dimethylsiloxane-block-hydroxyethylacrylate), poly(dimethylsiloxane-block-methylmethacrylate), poly(dimethylsiloxane-block-t-butylmethacrylate), poly(dimethylsiloxane-block-1-ethoxyethylmethacrylate), poly(dimethylsiloxane-block-6-(4′-cyanobiphenyl-4-yloxy)hexylmethacrylate), poly(dimethylsiloxane-block-ε-caprolactone), poly(dimethylsiloxane-block-lactide), poly(2-vinylpyridine-block-adipic anhydride), poly(ethylene-block-methylmethacrylate) and poly(ethylene-block-4-vinylpyridine).

The nano-composite layer may have a cylindrical or lamellar structure in which the block, which contains the nanoparticles including the light absorptive element or the oxide or compound thereof, has a single diameter of 5 to 200 nm.

According to another aspect of the present invention, there is provided a polarizing plate including the absorptive polarizer as described above.

According to another aspect of the present invention, there is provided a display device including the polarizing plate as described above.

According to another aspect of the present invention, there is provided a method for manufacturing an absorptive polarizer, including: coating a substrate film with a solution which includes 100 wt. parts of a block copolymer including first and second blocks combined therein, and 0.01 to 30 wt. parts of nanoparticles including a light absorptive element or an oxide or compound thereof.

According to another aspect of the present invention, there is provided a method for manufacturing an absorptive polarizer, including: extruding a solution which includes 100 wt. parts of a block copolymer including the first and second blocks combined therein, and 0.01 to 30 wt. parts of nanoparticles including a light absorptive element or an oxide or compound thereof.

The method may further include applying an electric or magnetic field to align the nanoparticles including the light absorptive element or the oxide or compound thereof, after the coating or extruding process.

### Advantageous Effects

The present invention may provide an absorptive polarizer with excellent durability, which can retain polarization properties such as polarization degree and transmittance even when it is exposed to hot and humid environments for a long time.

Further, the absorptive polarizer according to the present invention and an image display device including the same may be effectively utilized when it is delivered through hot and humid regions such as tropical zones, areas near the ocean, equatorial regions, or the like, or used in the same.

Further, the present invention may secure uniformity of nano-metallic particles in planes, thus attaining polarization degree and transmittance equal to or greater than those of any conventional polarizer typically prepared by a drawing process.

Further, according to the present invention, a large-area absorptive polarizer may be easily prepared at relative low production costs.

### BRIEF DESCRIPTION OF THE DRAWINGS

FIG. 1 is TEM photographs illustrating surfaces of an absorptive polarizer prepared according to one embodiment of the present invention.

FIG. 2 is a diagram schematically illustrating a structure of the absorptive polarizer prepared according to one embodiment of the present invention.

### MODES FOR CARRYING OUT THE INVENTION

The present invention relates to an absorptive polarizer which has excellent durability and superior polarization degree and transmittance even when it is exposed to hot and humid environments for a long time, as well as a method for manufacturing the same.

Hereinafter, the present invention will be described in more detail.

The absorptive polarizer of the present invention may include a nano-composite layer in which nanoparticles including a light absorptive element or an oxide or compound thereof are selectively contained in a block copolymer having a first block and a second block which are separately aligned therein

The block copolymer of the present invention may include the first and second blocks which are combined therein to form a linear structure, wherein the nanoparticles may be selectively placed on the linear structure of the first block or the second block in the block copolymer.

The block copolymer may be phase-separated by self-assembly, thus enabling the first and second blocks to be separately aligned. Consequently, the nanoparticles placed on the first block or second block may also be aligned.

The block copolymer may be at least one selected from a group consisting of poly(styrene-block-methylmethacrylate), poly(styrene-block-4-vinylpyridine), poly(styrene-block-2-vinylpyridine), poly(methylmethacrylate-block-trifluoroethylmethacrylate), poly(methacrylate-block-2-pyranoxyethylmethacrylate), poly(n-butylacrylate-block-dimethylsilane-co-diphenylsilane, poly(t-butylacrylate-block-4-vinylpyridine), poly(t-butylmethacrylate-block-2-vinylpyridine), poly(2-ethylhexylacrylate-block-4-vinylpyridine), poly(2-hydroxylethylacrylate-block-neopentylacrylate), poly(2-hydroxylethylacrylate-block-n-butyl methacrylate), poly(2-hydroxylethylmethacrylate-block-neopentylmethacrylate), poly(2-hydroxylethylmethacrylate-block-t-butylmethacrylate), poly(butadiene(1,2)-block-t-butylacrylate), poly(butadiene(1,4)-block-t-butylacrylate), poly(butadiene(1,2)-block-i-butylmethacrylate), poly(butadiene(1,2)-block-methylmethacrylate), poly(butadiene(1,4)-block-methylmethacrylate), poly(butadiene(1,2)-block-s-butylmethacrylate), poly(butadiene(1,2)-block-t-butylmethacrylate), poly(butadiene(1,4)-block-dimethylsilane), poly(butadiene(1,4)-block-ε-caprolactone), poly(butadiene(1,2)-block-lactide), poly(butadiene(1,4)-block-lactide), poly(butadiene(1,4)-block-4-vinylpyridine), poly(isopropene(1,2)-block-4-vinylpyridine), poly(isopropene(1,4)-block-4-vinylpyridine), poly(isopropene(1,4)-block-2-vinylpyridine), poly(isopropene(1,4)-block-methyl methacrylate(syndiotic)), poly(isobutylene-block-dimethylsilane), poly(isobutylene-block-methylmethacrylate), poly(isobutylene-block-t-butylmethacrylate), poly(isopropene-block-ε-caprolactone), poly(isopro-block-4-vinylpyridine), poly(styrene-block-4-bipyridylmethylacrylate), poly(styrene-block-cyclohexylmethacrylate), poly(styrene-block-dispersed 1-acrylate), poly(styrene-block-ethylmethacrylate), poly(styrene-block-lactide), poly(styrene-block-methylmethacrylate), poly(styrene-block-N,N-dimethylaminomethacrylate), poly(styrene-block-n-butylacrylate), poly(styrene-block-n-butylmethacrylate), poly(styrene-block-n-propylmethacrylate), poly(styrene-block-nylon 6), poly(styrene-block-t-butylacrylate), poly(styrene-block-t-butylmethacrylate), poly(styrene-block-ε-caprolactone), poly(styrene-block-2-cholesteryl oxycarbonyloxyethylmethacrylate), poly(styrene-block-2-hydroxyethylmethacrylate), poly(styrene-block-2-hydroxypropylmethacrylate), poly(styrene-block-2-vinylpyridine), poly(styrene-block-4-hydroxylstyrene), poly(styrene-block-4-methoxystyrene), poly(styrene-block-4-vinylpyridine), poly(α-methylstyrene-block-4-vinylpyridine), poly(4-aminomethylstyrene-block-styrene), poly(4-methoxystyrene-block-ethylmethacrylate), poly(4-methoxystyrene-block-t-butylacrylate), poly(p-chloromethylstyrene-block-t-butylacrylate), poly(2-vinylnaphthalene-block-methylmethacrylate), poly(2-vinylnaphthalene-block-n-butylacrylate), poly(2-vinylnaphthalene-block-t-butylacrylate), poly(2-vinylpyridine-block-methylmethacrylate), poly (4-vinylpyridine-block-methylmethacrylate), poly(2-vinylpyridine-block-t-butylmethacrylate), poly(2-vinylpyridine-block-methyl acrylic acid), poly(2-vinylpyridine-block-ε-caprolactone), poly(2-vinylpyridine-block-dimethylsiloxane), poly(dimethylsiloxane-block-n-butylacrylate), poly(dimethylsiloxane-block-t-butylacrylate), poly(dimethylsiloxane-block-hydroxyethylacrylate), poly(dimethylsiloxane-block-methylmethacrylate), poly(dimethylsiloxane-block-t-butylmethacrylate), poly(dimethylsiloxane-block-1-ethoxyethylmethacrylate), poly(dimethylsiloxane-block-6-(4′-cyanobiphenyl-4-yloxy)hexylmethacrylate), poly(dimethylsiloxane-block-ε-caprolactone), poly(dimethylsiloxane-block-lactide), poly(2-vinylpyridine-block-adipic anhydride), poly(ethylene-block-methylmethacrylate) and poly(ethylene-block-4-vinylpyridine).

The first and second blocks according to the present invention may refer to not only blocks including repeat units of the same polymer, respectively, but also blocks including repeat units of any other polymer having similar properties. In other words, the block copolymer of the present invention may include double, triple and/or multiple block copolymers, and is not particularly limited so far as such block copolymer may be separated and aligned into two blocks due to specific properties.

For example, the first and second blocks may be a hydrophilic block and a hydrophobic block, respectively, which are separately aligned on the basis of properties. In this case, nanoparticles may be placed on the hydrophilic or the hydrophobic block.

The nanoparticles including a light absorptive element or an oxide or compound thereof are not particularly limited so far as these substances may absorb light, however, such light absorptive element or the oxide or compound thereof may include, for example, at least one selected from a group consisting of Ag, Au, Pt, Ti, Fe, Co, Cr, Cu, Ni, Zn, Mn, Cd, W, Al, Pb, Ga, Si, AS, Fe₂O₃, Fe₃O₄, CrO₂, SiO₂, Al₂O₃, TiO₂, PbS, Fe5₂, ZnS, GaP, GaAs, InP, InAs, InSb and CdSe.

Further, the nanoparticle may be subjected to surface treatment so as to have affinity with the first block or the second block. Methods for surface treatment of the nanoparticles are known in the related art and those skilled in the art may easily execute the same, and therefore will not be described in detail. For example, a method of modifying the surface of a nanoparticle so as to have a hydrophobic or hydrophilic functional group may be adopted.

The nanoparticles used herein may have an average diameter of 1 to 100 nm. If the average diameter is less than 1 nm, light is not sufficiently absorbed and not to form polarized light. When the average diameter exceeds 100 nm, there is a difficulty in selective dispersion in the block formed by the block copolymer.

Such nanoparticles may be included in a range of 0.01 to 30 wt. parts to 100 wt. parts of the block copolymer. If a content of the nanoparticles is less than 0.01 wt. parts, light absorption is not enough. When the above content exceeds 30 wt. parts, a film becomes opaque and may not sufficiently transmit light.

A nano-composite layer containing the block copolymer and nanoparticles may have a variety of nano-structures, for example, structures in morphologies of spheres, cylinders, gyroids and/or lamellae formed by appropriately adjusting a constitutional ratio (wt. ratio) of two different polymer blocks. For example, the lamellar structure may have a constitutional ratio (wt. ratio) of 50:50 in terms of two different polymer blocks.

Considering aspects of light absorption efficiency and uniformity in thickness direction, the nano-composite layer of the present invention preferably has a cylindrical structure. The cylindrical structure may include a block, which contains the nanoparticles of a light absorptive element, or an oxide or compound thereof, having a single diameter of 5 to 200 nm.

Further, a thickness and height of each of the first and second blocks in the lamellar structure may be controlled on the basis of molecular weights of individual block components.

The absorptive polarizer according to the present invention may be prepared by coating a substrate film with a solution which includes a block copolymer having first and second blocks combined therein, and nanoparticles including a light absorptive element or an oxide or compound thereof. Herein, a shear flow occurs in the solution during coating, so that the blocks may be aligned in a flow direction of the solution or a direction perpendicular to the flow direction of the solution. The nanoparticles may be selectively aligned on either the first block or the second block, thus having anisotropic light absorption properties.

The coating may be executed according to any conventional method, and preferably, spin-coating, bar coating, comma coating, slot-die coating, screen printing, or the like. A thickness of a coating layer formed by coating may be appropriately controlled depending on the desired polarization degree and/or transmittance of the polarizer, and preferably, ranges from 20 to 10,000 nm.

Further, the block copolymer of the present invention may have a variety of structures through a self-assembly according to heat treatment after coating. Therefore, the block copolymer may be subjected to the heat treatment after coating, as necessary.

Conditions for the heat treatment to allow the self-assembly of the block copolymer may be set in a range of a glass transition temperature or more at which the block copolymer has fluidity to a temperature or less at which the block copolymer is not thermally degraded. For example, poly(styrene-b-methyl methacrylate) may be self-assembled at a temperature of 100° C. or more, whereas it needs a long period of time to complete the self-assembly at a low temperature. Accordingly, heat treatment may be executed at about 250° C. under a high vacuum atmosphere excluding oxygen. In this case, due to active flowing of molecules, a regular self-assembly may be completed in a short time.

Further, the absorptive polarizer according to the present invention may be prepared by extruding a melting substance which includes a block copolymer having first and second blocks combined therein, and nanoparticles including a light absorptive element or an oxide or compound thereof. Herein, flowing may occur during extrusion to thus align the nanoparticles.

The extruding may be executed by any conventional method, and preferably, a single screw extruder, a twin screw extruder, a calendaring, or a combination thereof.

The extruding may be executed at a temperature substantially identical to that used in the heat treatment conditions described above.

Further, the present invention may further include a process of applying an electric or magnetic field to align the nanoparticles including the light absorptive element or an oxide or compound thereof, after the above-described coating or extruding process.

The applied electric or magnetic field may provide polarizability and magnetic property to the nanoparticles, thus enhancing orientation and uniformity in alignment of the nanoparticles.

Depending on types of nanoparticle used herein, conditions for application of the electric or magnetic field may be appropriately controlled. For example, Fe₂O₃ is preferably subjected to coating or extruding under an environment where an external magnetic field is formed.

The present invention may fabricate a polarizing plate including the absorptive polarizer described above and a display device including the same. The polarizing plate and display device used herein may have any typical configuration generally used in the related art, without particular limitation thereof.

Hereinafter, preferred embodiments will be described to more concretely understand the present invention with reference to examples and comparative examples. However, those skilled in the art will appreciate that such embodiments are provided for illustrative purposes and do not limit subject matters to be protected as disclosed in the detailed description and appended claims. Therefore, it will be apparent to those skilled in the art various alterations and modifications of the embodiments are possible within the scope and spirit of the present invention and duly included within the range as defined by the appended claims.

### EXAMPLE 1

To 100 wt. parts of a block copolymer (PS-b-PMPA) including a first polystyrene block and a second polymethyl methacrylate block wherein each has a molecular weight of 52,000 g/mol, and a mixing ratio of the first and second blocks is 25:75 molar ratio, 1 wt. part of Fe₂O₃ nanoparticles having an average diameter of 10 nm and a hydrocarbon functional group formed on a surface of nanoparticle so as to have affinity with the first polystyrene block, and 90 wt. parts of toluene are added and mixed to prepare a solution.

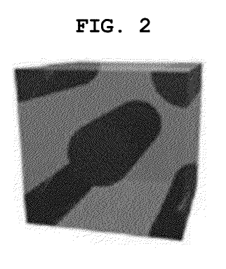

The prepared solution was applied to a face of a transparent substrate film (Fuji Film Co. Ltd., TD6OUL) through spin-coating, and the coated film was subjected to heat treatment at 150° C. under a high vacuum atmosphere for 48 hours to induce self-assembly of PS-b-PMMA. As a result, an absorptive polarizer having a cylindrical structure in which the first and second blocks are separately aligned was prepared (FIG. 2).

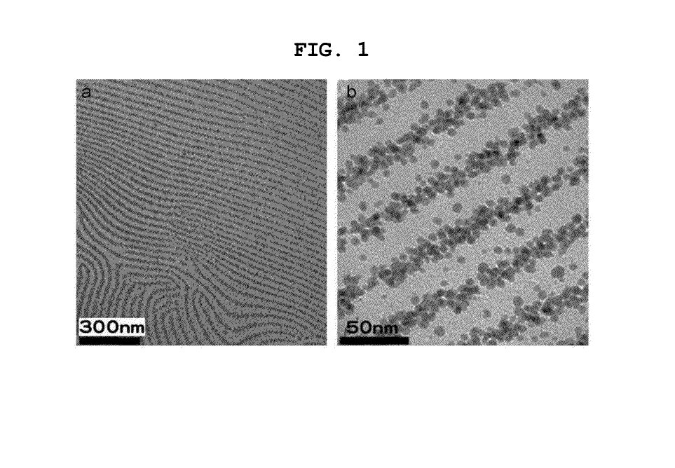

FIG. 1 is TEM photographs of the absorptive polarizer prepared as described above, which may be seen that Fe₂O₃ metal nanoparticles are aligned therein.

### EXAMPLE 2

An absorptive polarizer was prepared by the same procedures as described in Example 1, except that a magnetic field of 200 kA/m was applied at 150° C. under a high vacuum atmosphere, after heat treatment.

### EXAMPLE 3

An absorptive polarizer was prepared by the same procedures as described in Example 1, except that a mixed resin of the block copolymer (PS-b-PMMA) and Fe₂O₃ nanoparticles was extruded at a temperature condition of 150° C.

### EXAMPLE 4

An absorptive polarizer was prepared by the same procedures as described in Example 3, except that a magnetic field of 200 kA/m was applied after the extruding process. COMPARATIVE EXAMPLE 1

A polyvinylalcohol film with a thickness of 75 μm was drawn in a total 5-fold drawing ratio. Then, the drawn film was subjected to iodine adsorption to have polarization performance, followed by drying the same, to prepare an absorptive polarizer containing iodine adsorbed and aligned therein.

### COMPARATIVE EXAMPLE 2

An absorptive polarizer was prepared by the same procedures as described in Example 1, except that the nanoparticles were replaced by a dichroic dye.

### EXPERIMENTAL EXAMPLE

After measuring physical properties of the polarizers prepared in the examples and comparative examples as described above according to the following methods, and results thereof are shown in Table 1.

(1) Polarization Degree and Transmittance

After cutting each of the prepared polarizers into a size of 4 cm×4 cm, polarization degree and transmittance were measured using a UV-visible spectrometer (V-7100, manufactured by JASCO Co.). The polarization degree is defined by Equation 1 below.

$$Polarization degree ( P ) = {[ \frac{( {T}_{1} - {T}_{2} )}{( {T}_{1} + {T}_{2} )} ]}^{1 \text{/} 2} \qquad [ Equation 1 ]$$

(wherein T₁ represents a parallel transmittance obtained when a pair of polarizers were aligned in such a way that absorption axes thereof were in parallel; and T₂ represents an orthogonal transmittance obtained when a pair of polarizers were aligned in such a way that absorption axes thereof were perpendicular to each other).

Further, after leaving the polarizer under hot and humid conditions including a temperature of 70° C. and a relative humidity of 95% RH, the polarization degree and transmittance were measured under the same conditions as described above. (2) Standard deviation of Polarization Degree (Confirmation of Uniformity of Nanoparticles in Planes)

After randomly sampling 15 points in the prepared polarizer in a size of 4 cm×4 cm, the polarization degree was measured and a degree of dispersion of the resulted values was calculated as a standard deviation.

TABLE 1

| | | | After leaving under | | Deviation of |
|---|---|---|---|---|---|
| | | | hot and humid | | polarization |
| | Initial | | conditions | | degree in |
| | Polarization | | Polarization | | planes |
| | degree | Transmittance | degree | Transmittance | (standard |
| Section | (%) | (%) | (%) | (%) | deviation, %) |
| Example 1 | 85 | 41 | 85 | 41 | 10 |
| Example 2 | 97 | 42 | 97 | 42 | 0.2 |
| Example 3 | 90 | 41 | 90 | 41 | 1 |
| Example 4 | 98 | 42 | 98 | 42 | 0.1 |
| Comparative | 99 | 40 | 70 | 60 | 0.1 |
| Example 1 | | | | | |
| Comparative | 80 | 45 | 78 | 42 | 10 |
| Example 2 | | | | | |

As shown in Table 1 above, it can be seen that the absorptive polarizers prepared in Examples 1 to 4 had excellent durability to thus retain polarization properties such as polarization degree and transmittance. Further, since the deviation of polarization degree in planes according to the present invention substantially equal to or greater than those of any conventional art was maintained, it can be seen that uniformity of nanoparticles in planes was successfully ensured.

What is claimed is:

1. An absorptive polarizer, comprising:
a nano-composite layer in which nanoparticles including a light absorptive element or an oxide or compound thereof are selectively contained in a block copolymer having a first block and a second block which are separately aligned therein.

2. The polarizer according to claim 1, wherein the nanoparticles are subjected to surface treatment so as to have affinity with the first block or the second block.

3. The polarizer according to claim 2, wherein the nanoparticles have an average diameter of 1 to 100 nm.

4. The polarizer according to claim 3, wherein the light absorptive element or an oxide or compound thereof is at least one selected from a group consisting of Ag, Au, Pt, Ti, Fe, Co, Cr, Cu, Ni, Zn, Mn, Cd, W, Al, Pb, Ga, Si, AS, Fe₂O₃, Fe₃O₄, CrO₂, SiO₂, Al₂O₃, TiO₂, PbS, FeS₂, ZnS, GaP, GaAs, InP, InAs, InSb and CdSe.

5. The polarizer according to claim 1, wherein the nanoparticles are contained in an amount of 0.01 to 30 wt. parts to 100 wt. parts of the block copolymer.

6. The polarizer according to claim 1, wherein the block copolymer is at least one selected from a group consisting of poly(styrene-block-methylmethacrylate), poly(styrene-block-4-vinylpyridine), poly(styrene-block-2-vinylpyridine), poly(methylmethacrylate-block-trifluoroethylmethacrylate), poly(methacrylate-block-2-pyranoxyethylmethacrylate), poly(n-butylacrylate-block-dimethylsilane-co-diphenylsilane, poly(t-butylacrylate-block-4-vinylpyridine), poly(t-butylmethacrylate-block-2-vinylpyridine), poly(2-ethylhexylacrylate-block-4-vinylpyridine), poly(2-hydroxylethylacrylate-block-neopentylacrylate), poly(2-hydroxylethylacrylate-block-n-butyl methacrylate), poly(2-hydroxylethylmethacrylate-block-neopentylmethacrylate), poly(2-hydroxylethylmethacrylate-block-t-butylmethacrylate), poly(butadiene(1,2)-block-t-butylacrylate), poly(butadiene(1,4)-block-t-butylacrylate), poly(butadiene(1,2)-block-i-butylmethacrylate), poly(butadiene(1,2)-block-methylmethacrylate), poly(butadiene(1,4)-block-methylmethacrylate), poly(butadiene(1,2)-block-s-butylmethacrylate), poly(butadiene(1,2)-block-t-butylmethacrylate), poly(butadiene(1,4)-block-dimethylsilane), poly(butadiene(1,4)-block-ε-caprolactone), poly(butadiene(1,2)-block-lactide), poly(butadiene(1,4)-block-lactide), poly(butadiene(1,4)-block-4-vinylpyridine), poly(isopropene(1,2)-block-4-vinylpyridine), poly(isopropene(1,4)-block-4-vinylpyridine), poly(isopropene(1,4)-block-2-vinylpyridine), poly(isopropene(1,4)-block-methyl methacrylate(syndiotic)), poly(isobutylene-block-dimethylsilane), poly(isobutylene-block-methylmethacrylate), poly(isobutylene-block-t-butylmethacrylate), poly(isopropene-block-ε-caprolactone), poly(isopro-block-4-vinylpyridine), poly(styrene-block-4-bipyridylmethylacrylate), polystyrene-block-cyclohexylmethacrylate), poly(styrene-block-dispersed 1-acrylate), poly(styrene-block-ethylmethacrylate), poly(styrene-block-lactide), poly(styrene-block-methylmethacrylate), poly(styrene-block-N,N-dimethylaminomethacrylate), poly(styrene-block-n-butylacrylate), poly(styrene-block-n-butylmethacrylate), poly(styrene-block-n-propylmethacrylate), poly(styrene-block-nylon 6), poly(styrene-block-t-butylacrylate), poly(styrene-block-t-butylmethacrylate), poly(styrene-block-ε-caprolactone), poly(styrene-block-2-cholesteryl oxycarbonyloxyethylmethacrylate), poly(styrene-block-2-hydroxyethylmethacrylate), poly(styrene-block-2-hydroxypropylmethacrylate), poly(styrene-block-2-vinylpyridine), poly(styrene-block-4-hydroxylstyrene), poly(styrene-block-4-methoxystyrene), poly(styrene-block-4-vinylpyridine), poly(α-methylstyrene-block-4-vinylpyridine), poly(4-aminomethylstyrene-block-styrene), poly (4-methoxystyrene-block-ethylmethacrylate), poly(4-methoxystyrene-block-t-butylacrylate), poly(p-chloromethylstyrene-block-t-butylacrylate), poly(2-vinylnaphthalene-block-methylmethacrylate), poly(2-vinylnaphthalene-block-n-butylacrylate), poly(2-vinylnaphthalene-block-t-butylacrylate), poly(2-vinylpyridine-block-methylmethacrylate), poly(4-vinylpyridine-block-methylmethacrylate), poly(2-vinylpyridine-block-t-butylmethacrylate), poly(2-vinylpyridine-block-methyl acrylic acid), poly(2-vinylpyridine-block-ε-caprolactone), poly(2-vinylpyridine-block-dimethylsiloxane), poly(dimethylsiloxane-block-n-butylacrylate), poly(dimethylsiloxane-block-t-butylacrylate), poly(dimethylsiloxane-block-hydroxyethylacrylate), poly(dimethylsiloxane-block-methylmethacrylate), poly(dimethylsiloxane-block-t-butylmethacrylate), poly(dimethylsiloxane-block-1-ethoxyethylmethacrylate), poly(dimethylsiloxane-block-6-(4′-cyanobiphenyl-4-yloxy)hexylmethacrylate), poly(dimethylsiloxane-block-ε-caprolactone), poly(dimethylsiloxane-block-lactide), poly(2-vinylpyridine-block-adipic anhydride), poly(ethylene-block-methylmethacrylate) and poly(ethylene-block-4-vinylpyridine).

7. The polarizer according to claim 1, wherein the nano-composite layer has a cylindrical or lamellar structure in which the block, which contains the nanoparticles including the light absorptive element or the oxide or compound thereof, has a single diameter of 5 to 200 nm.

8. A polarizing plate comprising the absorptive polarizer according to claim 1.

9. A display device comprising the polarizing plate according to claim 8.

10. A method for manufacturing an absorptive polarizer, comprising:
coating a substrate film with a solution which includes 100 wt. parts of a block copolymer including first and second blocks combined therein, and 0.01 to 30 wt. parts of nanoparticles including a light absorptive element or an oxide or compound thereof.

11. A method for manufacturing an absorptive polarizer, comprising:
extruding a solution which includes 100 wt. parts of a block copolymer including first and second blocks combined therein, and 0.01 to 30 wt. parts of nanoparticles including a light absorptive element or an oxide or compound thereof.

12. The method according to claim 10, further comprising applying an electric or magnetic field to align the nanoparticles including the light absorptive element or the oxide or compound thereof, after the coating or extruding process.

13. The method according to claim 11, further comprising applying an electric or magnetic field to align the nanoparticles including the light absorptive element or the oxide or compound thereof, after the coating or extruding process.

14. A polarizing plate comprising the absorptive polarizer according to claim 3.

15. A display device comprising the polarizing plate according to claim 14.

16. A polarizing plate comprising the absorptive polarizer according to claim 5.

17. A display device comprising the polarizing plate according to claim 16.

18. A polarizing plate comprising the absorptive polarizer according to claim 6.

19. A polarizing plate comprising the absorptive polarizer according to claim 7.

20. A display device comprising the polarizing plate according to claim 19.
